(19) United States
(12) Patent Application Publication
(10) Pub. No.: US 2010/0046572 A1
(43) Pub. Date: Feb. 25, 2010

(54) Photonic-Crystal-Based Photon Extractor for High-Yield Optical Microsources

(75) Inventors: Alfredo De Rossi, Paris (FR); Sylvain Combrie, Paris (FR); Nguyen Vy Quynh Tran, Dong Nai (VN)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly Sur Seine (FR)

(21) Appl. No.: 12/499,200

(22) Filed: Jul. 8, 2009

(30) Foreign Application Priority Data
Jul. 11, 2008 (FR) 08 03984

(51) Int. Cl. H01S 3/08

(52) U.S. Cl. 372/96

(57) ABSTRACT

The invention relates to a photon extractor comprising a photonic-crystal-based membrane having a plane defined by two perpendicular directions, comprising an array of features and a cavity devoid of features, from which photons may be extracted, characterized in that the membrane comprises at least one region close to the cavity, said region having features distributed with a double periodicity (a₁, 2a₁, a₂, 2a₂) along at least one direction.

### PRIORITY CLAIM

This application claims priority to French Patent Application Number 08 03984, entitled Photonic-Crystal-Based Photon Extractor for High-Yield Optical Microsources, filed on Jul. 11, 2008.

### BACKGROUND OF THE INVENTION

The field of the invention is that of microcavity optical devices and notably that of microcavity laser sources that have specific properties in terms of photon emission, very small size and very low consumption, these being particularly desirable for applications in the quantum communications field (cryptography, computation, etc.) or for what is called “extreme” integration (corresponding to about one thousand laser sources with consumption of the order of a microwatt).

Another application of the invention relates to the input/output coupling of on-membrane microstructures with the outside (optical fibre, interconnection).

Optical devices that may be of very small size produced using photonic crystals and having a cavity, from which light can be extracted, are already known.

In general, photonic crystals are structures having a dielectric index that varies periodically on the scale of the wavelength along one or more directions in space. FIG. 1 illustrates the intensity of the electric field of an electromagnetic wave propagating in this type of structure and shows the dispersion plot for a structure having a period a in the first Brillouin zone; the wavevector k lies within the 0<k<π/a interval. It is known for materials, for example semiconductors, to be artificially structured so as to benefit from the diffraction effects, thereby making it possible to produce passive and active optical functions necessary, for example, for fibre-optic telecommunication networks.

Moreover, one of the major attractions of such structures is that defects can be controllably inserted into the crystal. These defects may generate states at the bandgap frequencies of the crystal and thus produce an electromagnetic field propagating at these frequencies. It is therefore conceivable to control the propagation of the light within the crystal, and on the scale of the wavelength, via these defects. The use of these structures thus opens the way to the miniaturization of components in integrated optics.

Compared to the three-dimensional crystalline structures, it has been shown that a two-dimensional structure could be particularly advantageous. In such a case, crystals are produced in a thin semiconductor guiding layer, thereby providing better control and easier production technology compatible with conventional microelectronics technologies.

A very thin layer is isolated thus constituting a membrane which may typically have a thickness h of around 150 nanometres to 300 nanometres for the applications aimed at the spectral range between 1 micron and 1.6 microns. By a simple law this thickness can be adjusted so as to extend the application to other spectral ranges. The law is the following:

h between 0.1 and 0.3 times the wavelength.

Typically, the material used may be silicon or a semiconductor material based on elements of columns III and V of the Periodic Table of the Elements (“III-V” semiconductors, for example GaAs, AlGaAs, GaInP, InP, AlGaAsP, etc.) Other materials that may be envisaged are semiconductors of the II-VI family (for example ZnO) and SiN. A waveguide with a large variation in optical index is created within this membrane, as illustrated in FIG. 2. The speed of propagation of the waves and the dispersion of the guided modes may notably be regulated by varying the size of the features.

By creating a break in such a periodic structure, for example by omitting certain holes, it becomes possible to create a photonic cavity within which the energy remains stored. Such a cavity can then provide a filter function with resonance modes, or else it may constitute a laser cavity emitting in a plane perpendicular to the plane of the membrane.

However, according to the prior art, the light beam output from this type of structure remains highly divergent, as illustrated in FIG. 3, and requires a very powerful optical collection device to recover the energy. Moreover, the radiation pattern of the recovered optical beam is also not very homogeneous.

A group at the Korean Technology Institute (KAIST) has already proposed an empirical optimization of one type of cavity called a “hexapole”, described notably in the article by Se-Heon Kim, Sun-Kyung Kim, and Yong-Hee Lee, ”Vertical beaming of wavelength-scale photonic crystal resonators”, Physical Review B 73, 235117 (2006). It consists in generating point defects so as to break the periodicity of the features. However, this optimization is very sensitive to fabrication imperfections and in practice the tolerances required for obtaining a well-defined emission pattern cannot be achieved by the current fabrication technology.

### SUMMARY OF THE INVENTION

To solve these various problems, and notably that of extracting light satisfactorily from the photonic crystal, the present invention provides an optimized structure for extracting light from a photonic crystal, doing so with a radiation pattern having a high directivity and a uniform emission surface, based on reliable and reproducible technology.

More precisely, one subject of the invention is a photon extractor comprising a photonic-crystal-based membrane having a plane defined by two directions, comprising an array of features arranged so as to form an optical cavity, from which photons may be extracted, characterized in that the membrane comprises at least one region close to the cavity, said region having features distributed with a double periodicity (a₁, 2a₁, a₂, 2a₂) and along at least one direction.

According to one embodiment of the invention, the membrane has a double periodicity along two directions.

According to one embodiment of the invention, the double periodicities are produced by holes of different diameters.

According to one embodiment of the invention, the relative diameter variation is a few per cent.

According to one embodiment of the invention, the radius/periodicity ratio of the holes is between about 0.15 and 0.4.

According to one embodiment of the invention, the average hole diameter is around 250 nanometres, the smallest period ranging from around 200 nanometres to 400 nanometres for applications operating in the 900 nm to 1600 nm range.

According to one embodiment of the invention, the period of the structure relative to the wavelength corresponding to the spectral range in question is around 0.25 to 0.35.

According to one embodiment of the invention, the membrane is produced in a semiconductor material of GaAs or InP type.

According to one embodiment of the invention, the membrane is produced in an electrooptical material of LiNbO₃ type.

According to one embodiment of the invention, the membrane is produced in an optically non-linear material of the ferroelectric type.

Another subject of the invention is an optical device comprising a photonic extractor according to the invention, said photon extractor being coupled to a waveguide or to another microstructure produced on the membrane, so as to inject an optical signal into said membrane and extract an optical signal therefrom.

### BRIEF DESCRIPTION OF THE DRAWINGS

The invention will be better understood and other advantages will become apparent on reading the following description given by way of non-limiting example and in conjunction with the appended figures, in which:

FIG. 1 illustrates the intensity of the electrical field of an electromagnetic wave propagating in this type of structure and shows the dispersion plot for a structure having a period a in the first Brillouin zone, for which the wavevector k lies within the 0<k<π/a interval;

FIG. 2 illustrates a two-dimensional photonic crystal structure comprising a waveguide;

FIG. 3 illustrates qualitatively the angular distribution of the radiation from a photonic crystal cavity according to the known art;

FIGS. 4a and 4b define the spherical reference frame for the radiation relative to the orientation of a photonic crystal cavity, the corresponding cavity being represented in a Cartesian reference frame;

FIG. 5 illustrates the angular distribution of the radiation, typical of normalized intensity as a function of the polar coordinate θ for a cavity as shown in FIG. 4a;

FIG. 6 shows the radiation in the polar reference frame of the cavity example illustrated in FIG. 4a;

FIGS. 7a and 7b illustrate the phase of the component E_{y} of the electric field for cavities L2 and L3;

FIG. 8 illustrates the relationship between the phase of the electric field and the modification of the features for a cavity L3;

FIG. 9 illustrates the radiation pattern for a cavity L5 into which feature variations have been introduced close to the cavity;

FIG. 10 illustrates an example of a cavity L5 optimized for extraction;

FIG. 11 illustrates the radiation plot for the cavity illustrated in FIG. 10;

FIGS. 12a and 12b establish the connection between the optical modes propagating in the periodic structure shown in FIG. 12b and the dispersion plot shown in FIG. 12a in an example of a photonic crystal structure according to the invention;

FIGS. 13a and 13b illustrate one mode of a cavity in reciprocal space and the corresponding cavity in an example of a photonic crystal structure according to the prior art;

FIGS. 14a and 14b illustrate one mode of a cavity in reciprocal space and the corresponding modified cavity in an example of a photonic crystal structure according to the invention;

FIG. 15 illustrates an exemplary embodiment of a periodic structure modified along a single direction in accordance with the invention;

FIGS. 16a and 16b illustrate a first example of optimizing a cavity of the L5 type, FIG. 16a relating to the initial cavity and FIG. 16b relating to that used in an extractor according to the invention; and

FIGS. 17a and 17b illustrate a second example of optimizing a cavity of the L5 type, FIG. 17a relating to the initial cavity and FIG. 17b relating to that used in an extractor according to the invention.

### DETAILED DESCRIPTION OF THE PREFERRED EMBODIMENTS

In general, the photonic extractor comprises a photonic-crystal-based membrane with a periodic structure along two directions in its plane.

More precisely, a triangular periodic mesh is considered, the principal axes of said mesh forming an angle which may for example be 60°.

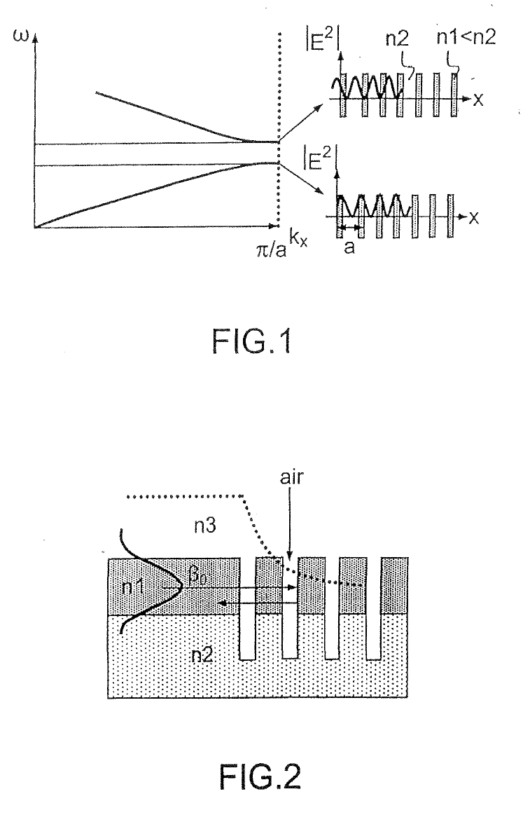

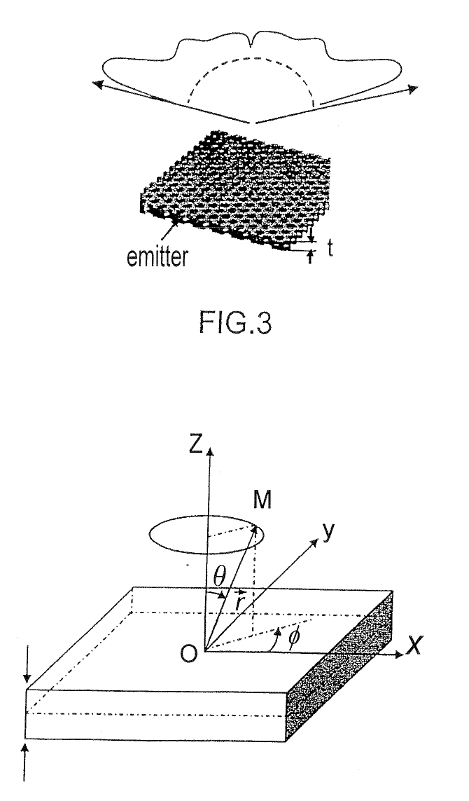

This structure comprises a cavity obtained by eliminating or modifying, locally, a number of the features, for example 3 features along a line, or more complex structures as described in the article by T. Asano et al., “Ultrahigh-Q Nanocavities in Two-Dimensional Photonic Crystal Slabs”, IEEE Journal of Selected Topics in Quantum Electronics, Vol, 12, No. 6, page 1123 (2006), FIGS. 1, 7, 13 and 17, the article by E. Kuramochi et al., “Ultrahigh-Q photonic crystal nanocavities realized by the local width modulation of a line defect”, Applied Physics Letters Vol. 88, page 041112 (2006), FIG. 1 and the article by K. Nozaki and T. Baba, “Laser characteristics with ultimate-small modal volume in photonic crystal slab point-shift nanolasers”, Applied Physics Letters Vol. 88, page 211101 (2006), from which photons may be extracted.

The structure used in an extractor according to the invention is characterized in that the membrane comprises at least one region close to the cavity, said region having features distributed with a double periodicity along at least one direction.

Thus, the present invention provides an optimization technique and examples of structures thus optimized that allow considerably better tolerance in terms of fabrication imperfections, while still ensuring the same level of coupling as the proposed “hexapole”-type structure.

The solution provided is based on the principle of band folding in a photonic crystal structure and makes it possible to concentrate the photon emission directions within a cone having a greatly increased directivity.

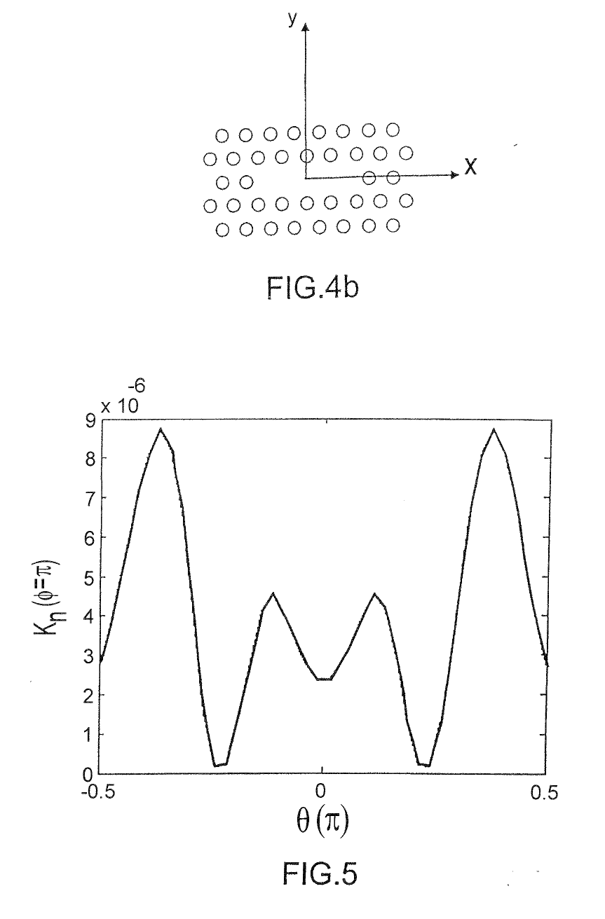

In general, a photonic cavity may be represented in a Cartesian reference frame and in a spherical reference frame, as illustrated in the FIGS. 4a and 4b respectively, which relate to an example of what is called an L3 cavity, because of the absence of three aligned holes. To validate the principle of the invention, we shall consider the distribution of the electric field Ey in the plane of symmetry of the cavity. The radiation intensity corresponding to the power radiated per solid angle is a quantity K dependent on the coordinates θ and φ. This quantity dependent on θ and φ in the cylindrical coordinate system represents how the cavity radiates and is linked to the Poynting vector \vec{I}(\vec{r}) through the equation:

$$K ( θ , φ ) = {lim}_{\vert r \vert \to ∞} \frac{\vec{I} ( \vec{r} ) {r}^{⋒}}{{\vert r \vert}^{2}} .$$

Here, the normalized radiation intensity is defined by:

$$\int {K}_{n} ( θ , φ ) sin θ d θ d φ = \frac{1}{Q} or {K}_{n} ( θ , φ ) = \frac{K ( θ ( φ )}{W ω}$$

where W is the energy of the cavity mode, ω is the resonant frequency and Q is the Q-factor of the cavity.

FIG. 5 thus illustrates an example of the variation in normalized intensity as a function of the polar coordinate θ for a very simple cavity having three aligned holes, as shown in FIG. 4a.

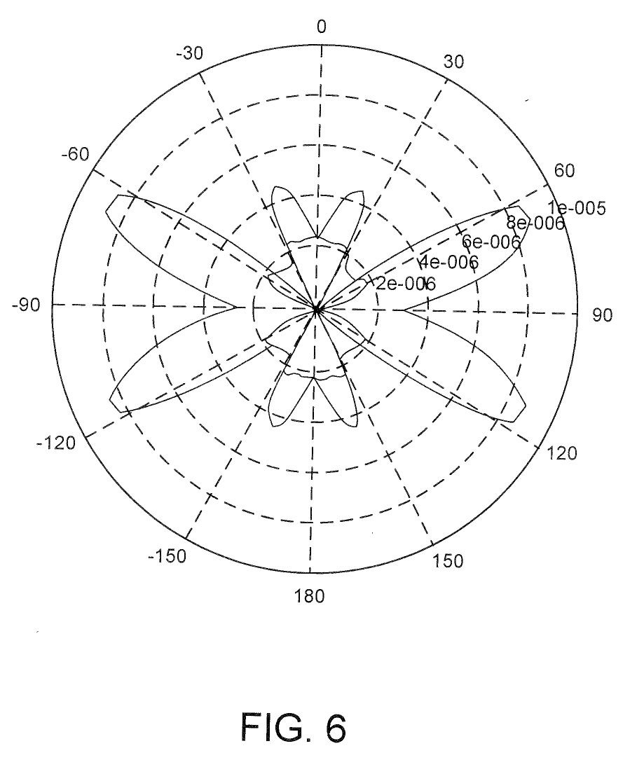

FIG. 6 shows the radiation pattern in the polar reference frame. This figure shows that the radiation from this cavity is small in the vertical direction (where θ=0) compared with other directions.

It is possible to introduce a quantity for assessing the vertical radiation from a cavity, namely:

$${η}_{coll}^{NA} = \frac{{\int }_{\vert sin ( θ ) \vert \leq NA}^{ } {K}_{n} sin θ d θ d φ}{\int {K}_{n} sin θ d θ d φ}$$

This quantity expresses the percentage of radiated energy lying within a numerical aperture NA relative to the total radiated energy, expressed by the normalized radiation intensity: ∫Kₛᵢₙ θdθdφ.

The following values have thus been established:

NA=0.1: η_{coll}^{NA}=0.29%;

NA=0.2: η_{coll}^{NA}=1.21%;

NA=0.4: η_{coll}^{NA}=9.01%;

NA=0.6: η_{coll}^{NA}=22.69%.

By improving the vertical radiation (i.e. obtaining a narrower radiated beam containing most of the radiated energy) it is possible to show that the quantity η_{coll}^{NA} is considerably increased.

To understand the link between the near field and far field, the Fraunhofer limit may firstly be considered. In this case, the Poynting vector is proportional to |Eₗₗ(kₗₗ)|²+η²|Hₗₗ(kₗₗ)|². In particular, the contribution to vertical emission is proportional to the value at k=0, which amounts to an integral over the near-field plane.

It may be seen that the cavity of L(2n) type, for example L2, has a field distribution that is antisymmetric with respect to its geometric centre.

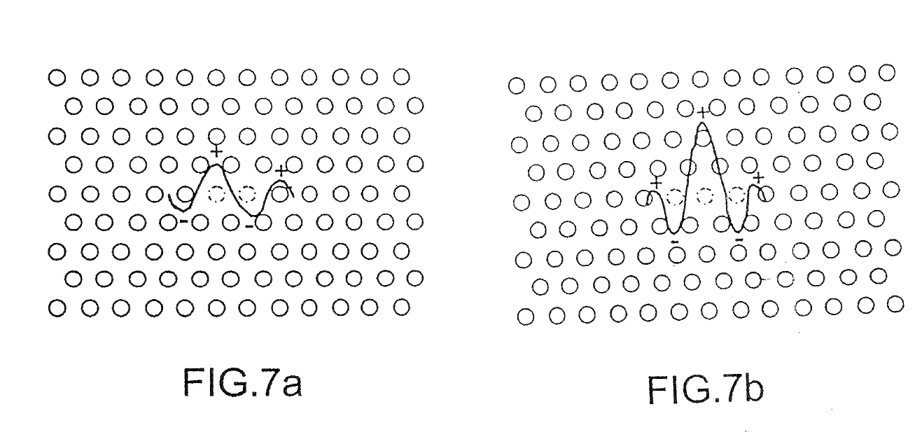

When performing a spatial integral so as to calculate the far field, the positive parts of the field are compensated for by the negative parts. As a result, very little energy remains within the light cone, as illustrated in FIGS. 7a and 7b. This means that the cavity radiates very weakly.

The behaviour of an L(2n+1), cavity, for example L3, differs from that of an L(2n). The field distribution has a very high intensity at the centre of the cavity (central hole) and lower elsewhere (two holes alongside). The spatial integral of this distribution gives a residual component in the light cone because of the negative parts, which are not large enough to be able to compensate for the positive parts. This type of cavity has the capacity to produce good radiation.

Thus, it is therefore apparent in the first place that an L(2n+1) cavity can radiate better than an L(2n) cavity.

The proposed optimization idea using this concept is based on forcing the difference between the positive and negative parts in the field distribution. The greater this difference, the stronger the vertical radiation.

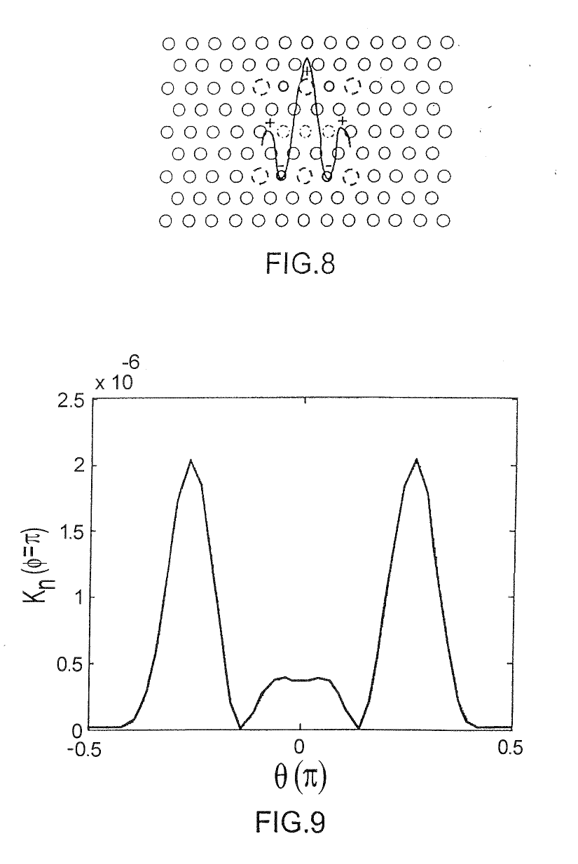

To force the difference in question, a small modulation may be performed on the radius of the holes lying along the second rows starting from the centre of the cavity, as shown in FIG. 8. The modulation reduces the negative part and increases the positive part, consequently obtaining stronger vertical radiation.

Similar measures have been carried out in the case of what is called an L5 cavity having five central features absent. The corresponding radiation pattern is illustrated in FIG. 9.

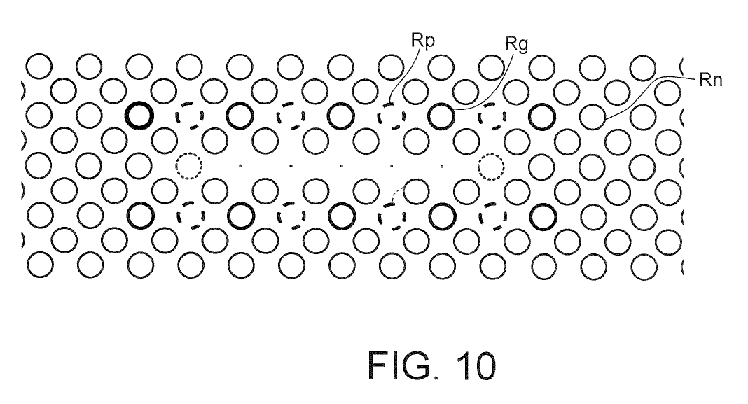

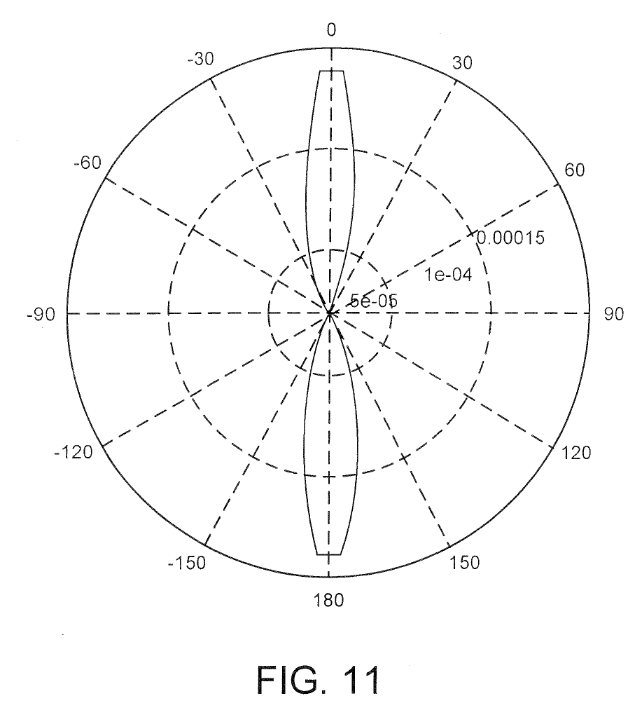

According to the invention, this cavity is optimized by enlarging and reducing the size of the holes in the second rows starting from the centre of the cavity, so as to create locally a double period. FIG. 10 illustrates a cavity comprising three radii, namely, (Rₚ, Rₙ and R_{g}) corresponding to the radius of small holes, normal holes and large holes respectively. The radiation pattern from said cavity is illustrated in FIG. 11.

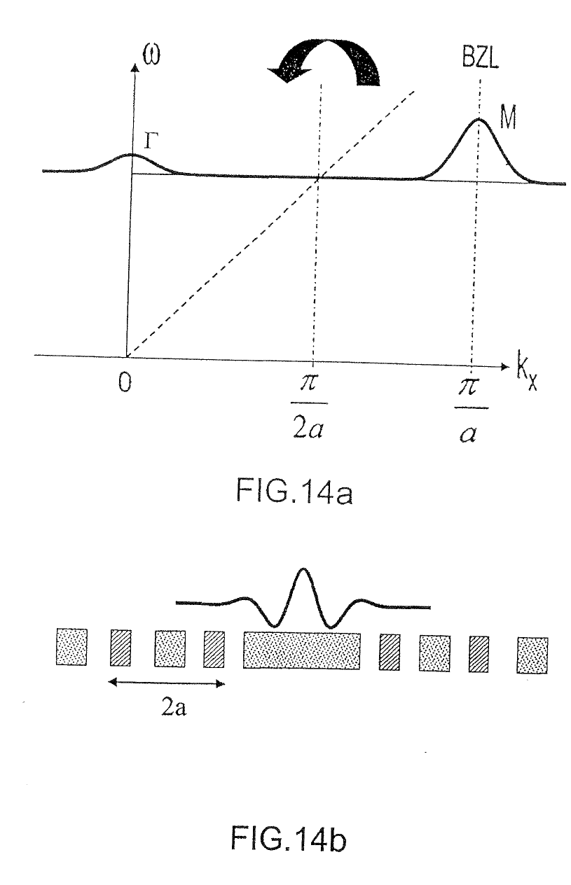

Based on these analyses carried out step by step, the Applicant has demonstrated that a systematic approach leading to band folding is extremely promising for concentrating the maximum amount of energy in a very tight directivity cone, as illustrated by the diagrams shown in FIGS. 14a and 14b.

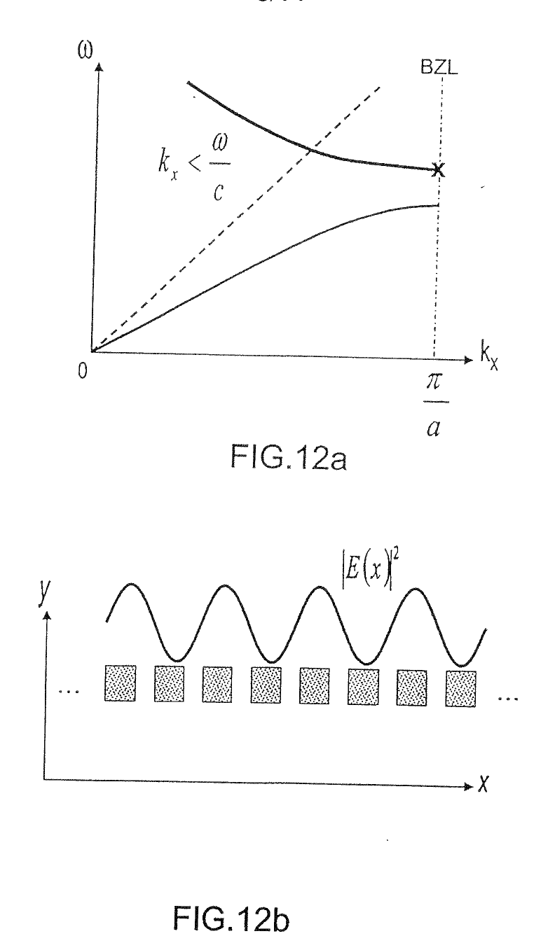

Firstly, the procedure for the periodic structures along a single direction is defined. FIGS. 12a and 12b establish the connection between the optical modes propagating in the periodic structure shown in FIG. 12b and the dispersion plot shown in FIG. 12a, which is represented in reciprocal space. If a is the period of the structure, the optical modes are represented by a continuum of points associating the frequency of the mode with its propagation vector k, which is between −π/a and π/a. Since the modes propagating in the two directions are identical, the plot is symmetric, and therefore a single representation over the 0 to π/a interval is sufficient. Each mode corresponds to one point on the curve shown in FIG. 12a. For example, the mode illustrated in FIG. 12b is represented by the point x in FIG. 12a.

As regards the membrane structures (the field of the invention), the reciprocal space is divided into two spaces. The space in which kₓ<ω/c corresponds to modes that radiate out of the plane of the structure. These modes are not suitable for propagation. In contrast, the modes such that kₓ>ω/c are well confined in the structure.

The angle of radiation θ relative to the perpendicular to the structure is given by the equation: sin θ=kₓc/ω. For example, if kₓ=0, the radiation is emitted along the vertical. The mode represented by the point x in FIG. 12a does not radiate.

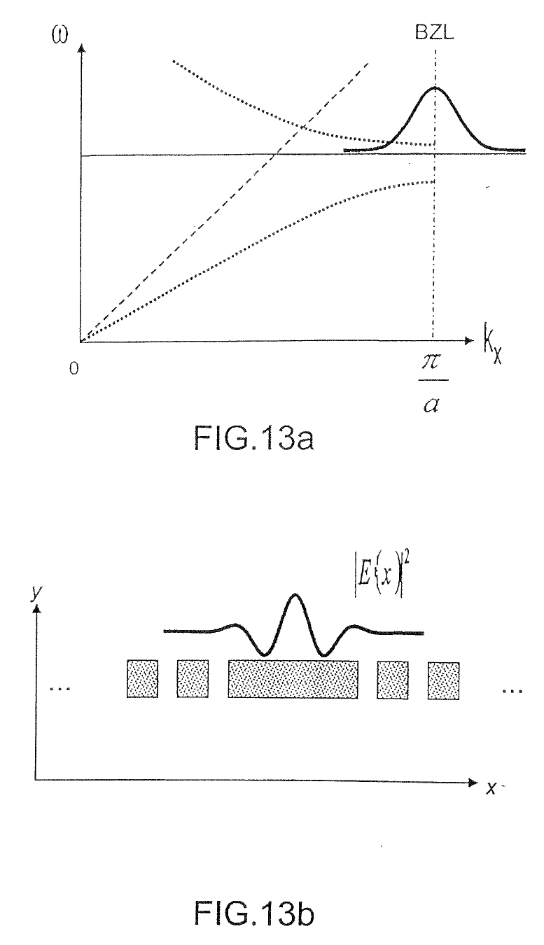

In contrast with a mode of a periodic structure, the mode of a cavity has a finite spatial extension. A cavity may be obtained from a periodic structure by introducing a perturbation in the periodicity, for example by omitting one feature, as shown in FIG. 13b.

The representation of the mode of a cavity in reciprocal space consists in a distribution that is centred on that point in reciprocal space which corresponds to the mode of the initial, unperturbed structure, as shown in FIG. 13a.

The distribution of the field in reciprocal space is such that part of the field also lies in the region kₓ<ω/c. This means that the entire cavity fabricated on a membrane radiates, thereby establishing a limitation intrinsic to their Q-factor (i.e. the energy retention capability).

However, these effects may be reduced to negligible levels by optimizing the design of the structure. Thus, it is currently possible to obtain Q-factors of the order of one million with this technology, as described notably in the literature: T. Asano et al., “Ultrahigh-Q Nanocavities in Two-Dimensional Photonic Crystal Slabs”, IEEE Journal of Selected Topics in Quantum Electronics, Vol. 12, no. 6, page 1123 (2006); E. Kuramochi et al., “Ultrahigh-Q photonic crystal nanocavities realized by the local width modulation of a line defect”, Applied Physics Letters Vol. 88, page 041112 (2006); and K. Nozaki and T. Baba, “Laser characteristics with ultimate-small modal volume in photonic crystal slab point-shift nanolasers”, Applied Physics Letters Vol. 88, page 211101 (2006).

The methods for optimizing the Q-factor do not in general take into account the angular distribution of the residual radiation. This depends on the distribution of the field in the region kₓ<ω/c of reciprocal space. It follows that the angular radiation plot is very irregular, as illustrated in FIG. 6.

The principle used in the present invention consists of a folding in reciprocal space, such that the peak of the distribution is reproduced with a scale factor at the point kₓ=0 (see FIG. 13a). It follows that the radiation forms at the angle θ=0 with a regular angular distribution, close to the optimum distribution of a Gaussian mode.

One very important particular case is that in which the principal peak is at the edge of the Brillouin zone (BZL). This is the case shown in FIG. 13a. In this case, it is sufficient to modify the structure so as introduce a period 2a as shown in FIG. 14b, for example by modifying the size of the features. The entity of this perturbation sets the scale factor between the principal peak (M) and the secondary peak (Γ). This is linked to the intensity of the coupling of the cavity with the emission mode.

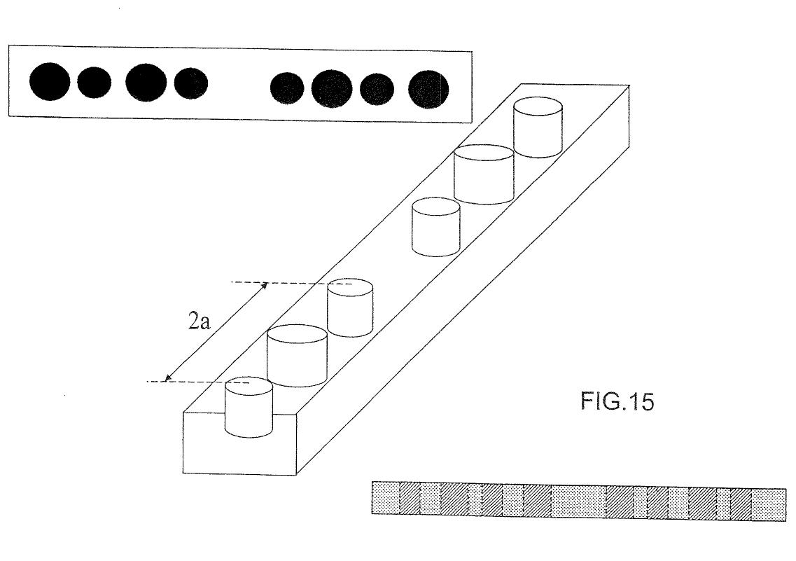

FIG. 15 illustrates one possible embodiment of periodic structures along a single direction.

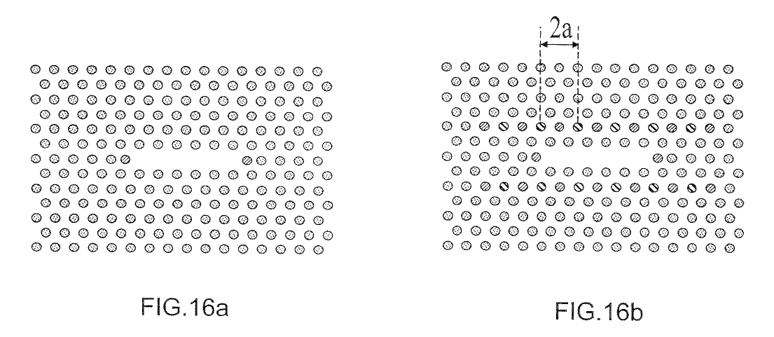

The extension of the principle to the case of two-dimensional structures is more complicated, but the principle is the same. FIGS. 16a and 16b illustrate how a cavity of L5 type (FIG. 16a) is optimized into an extractor (FIG. 16b), the radiation pattern of which is depicted in FIG. 11.

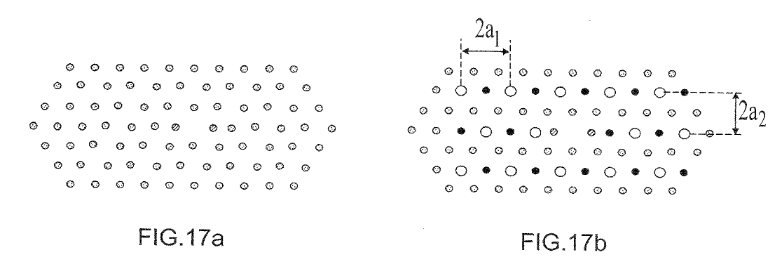

Another type of cavity that has been optimized by the same method is that described in the article by K. Nozaki and T. Baba, “Laser characteristics with ultimate-small modal volume in photonic crystal slab point-shift nanolasers”, Applied Physics Letters Vol. 88, page 211101 (2006). This is shown in FIG. 17a (original cavity) and 17b (extractor) with the double periodicity a₁ and a₂.

Exemplary embodiment of validation of the principle according to the invention:

The extractor according to the invention may consist of a membrane made of a semiconductor material of the silicon type or of the III-V material type, which may notably be GaAs, GaAlAs, GaInP, etc.

The thickness of the membrane may be of the order of a few hundred nanometres.

The periodicity of the features may be of the order of a few hundred nanometres, typically 400 nanometres.

The diameter of the features, which typically may be holes, may be around 250 nanometres. A ratio of the diameter of the features to the period of said features of typically around 0.15 to 0.35 is thus chosen.

According to the invention, the membrane includes a zone in which features are absent so as to create the cavity from which the photons are extracted—typically these may be a few units of features.

In a region close to the cavity, a double periodicity is created with features of different diameters. All the features separated by a period 2a are for example smaller holes and larger holes.

The invention described above enables a collection factor of around 80% to be achieved, this being sufficient for the most demanding applications (photon source for quantum computation for example).

What is claimed is:

1. Photon extractor comprising a photonic-crystal-based membrane having a plane defined by two directions, comprising an array of features arranged so as to form an optical cavity, from which photons may be extracted, in which the membrane comprises at least one region close to the cavity, said region having features distributed with a double periodicity (a₁, 2a₁, a₂, 2a₂) and along at least one direction, making it possible to obtain a radiation pattern having high directivity and a uniform emission surface.

2. Photon extractor according to claim 1, wherein the membrane comprises periodic features along two mutually orthogonal directions.

3. Photon extractor according to either of claims 1 and 2, in which the double periodicities are produced by holes of different diameters.

4. Photon extractor according to claim 3, in which the relative diameter variation is a few per cent.

5. Photon extractor according to either of claims 1 and 2, in which the double periodicities are produced by a displacement of the holes.

6. Photon extractor according to claim 5, in which the relative displacement is a few per cent.

7. Photon extractor according to one of claims 1 or 2, in which the radius/periodicity ratio of the holes is between about 0.15 and 0.4.

8. Photon extractor according to one of claims 1 or 2, in which the average hole diameter is around 250 nanometres, the smallest period being around 400 nanometres so as to emit photons in a spectral band ranging from around 1300 nm to 1600 nm, for applications in telecommunications.

9. Photon extractor according to one of claims 1 or 2, in which the period of the structure relative to the wavelength corresponding to the spectral range in question is around 0.25 to 0.35.

10. Photon extractor according to one of claims 1 or 2, in which the membrane is produced in a silicon-type semiconductor material.

11. Photon extractor according to one of claims 1 or 2, in which the membrane is produced in a III-V material of the GaAs, GaAlAs, InP, GaInP type.

12. Photon extractor according to one of claims 1 or 2, in which the membrane is produced in an electrooptic material of LiNbO₃ type.

13. Photon extractor according to one of claims 1 or 2, in which the membrane is produced in an optically non-linear material of the ferroelectric type.

14. Optical device comprising a photon extractor according to one of claims 1 or 2, said photon extractor being coupled to a waveguide or to another microstructure produced on the membrane, so as to inject an optical signal into said membrane and extract an optical signal therefrom.
